(19) United States
(12) Patent Application Publication
(10) Pub. No.: US 2016/0337061 A1
(43) Pub. Date: Nov. 17, 2016

(54) ACCESS POINT SYNCHRONIZATION IN SHARED SPECTRUM

(71) Applicant: QUALCOMM Incorporated, San Diego, CA (US)

(72) Inventors: Samel CELEBI, Summit, NJ (US); Ahmed Kamel SADEK, San Diego, CA (US); Rizwan Ehtesham AHMED, Hillsborough, NJ (US)

(21) Appl. No.: 14/711,464

(22) Filed: May 13, 2015

(51) Int. Cl. H04J 3/06; H04W 24/08; H04W 76/04; H04L 5/14

(52) U.S. Cl. CPC H04J 3/0638; H04L 5/1469; H04W 24/08; H04W 76/048

(57) ABSTRACT

Techniques for managing communication in accordance with a second radio access technology on a channel shared with a first radio access technology are disclosed. The management may comprise, for example, operating in accordance with a first radio access technology and monitoring the medium for first radio access technology signaling, determining a utilization metric associated with utilization of the medium by the first radio access technology signaling, determining whether absolute timing information is available, setting one or more parameters of a time division multiplexing communication pattern based on the utilization metric and the availability of the absolute timing information, and operating in accordance with a second radio access technology and cycling between activated periods and deactivated periods of communication over the medium in accordance with the time division multiplexing communication pattern.

Aspects of this disclosure relate generally to telecommunications, and more particularly to co-existence between wireless Radio Access Technologies (RATs) and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), etc.

In cellular networks, “macro cell” access points provide connectivity and coverage to a large number of users over a certain geographical area. A macro network deployment is carefully planned, designed, and implemented to offer good coverage over the geographical region. To improve indoor or other specific geographic coverage, such as for residential homes and office buildings, additional “small cell,” typically low-power access points have recently begun to be deployed to supplement conventional macro networks. Small cell access points may also provide incremental capacity growth, richer user experience, and so on.

Recently, small cell LTE operations, for example, have been extended into the unlicensed frequency band such as the Unlicensed National Information Infrastructure (U-NII) band used by Wireless Local Area Network (WLAN) technologies. This extension of small cell LTE operation is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “WiFi.”

### SUMMARY

Techniques for adaptive transmission and related operations in shared spectrum are disclosed.

In one example, an apparatus for managing communication in accordance with a second RAT on a channel shared with a first RAT is disclosed. The apparatus may include, for example, a first transceiver configured to operate in accordance with a first radio access technology and monitor the medium for first RAT signaling, a medium utilization analyzer configured to determine a utilization metric associated with utilization of the medium by the first RAT signaling, a timing module configured to determine whether absolute timing information is available, an operating mode controller configured to set one or more parameters of a Time Division Multiplexing (TDM) communication pattern based on the utilization metric and the availability of the absolute timing information, and a second transceiver configured to operate in accordance with a second RAT and to cycle between activated periods and deactivated periods of communication over the medium in accordance with the TDM communication pattern.

In another example, a method for managing communication in accordance with a second RAT on a channel shared with a first RAT is disclosed is disclosed. The method may comprise, for example, operating in accordance with a first radio access technology and monitoring the medium for first RAT signaling, determining a utilization metric associated with utilization of the medium by the first RAT signaling, determining whether absolute timing information is available, setting one or more parameters of a TDM communication pattern based on the utilization metric and the availability of the absolute timing information, and operating in accordance with a second RAT and cycling between activated periods and deactivated periods of communication over the medium in accordance with the TDM communication pattern.

In another example, another apparatus for managing communication in accordance with a second RAT on a channel shared with a first RAT is disclosed. The apparatus may comprise, for example, means for operating in accordance with a first radio access technology and monitoring the medium for first RAT signaling, means for determining a utilization metric associated with utilization of the medium by the first RAT signaling, means for determining whether absolute timing information is available means for setting one or more parameters of a TDM communication pattern based on the utilization metric and the availability of the absolute timing information, and means for operating in accordance with a second RAT and cycling between activated periods and deactivated periods of communication over the medium in accordance with the TDM communication pattern.

In another example, a computer-readable medium comprising at least one instruction for causing a processor to perform processes for managing communication in accordance with a second RAT on a channel shared with a first RAT is disclosed. The computer-readable medium comprising at least one instruction may comprise, for example, code for operating in accordance with a first radio access technology and monitoring the medium for first RAT signaling, code for determining a utilization metric associated with utilization of the medium by the first RAT signaling, code for determining whether absolute timing information is available, code for setting one or more parameters of a TDM communication pattern based on the utilization metric and the availability of the absolute timing information, and code for operating in accordance with a second RAT and cycling between activated periods and deactivated periods of communication over the medium in accordance with the TDM communication pattern.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including a access point in communication with an access terminal.

FIG. 2 illustrates certain aspects of a Carrier Sense Adaptive Transmission (CSAT) communication scheme for cycling cellular operation in accordance with a long-term TDM communication pattern.

FIG. 3 illustrates several examples of CSAT timing patterns for cycling cellular operation in accordance with a long-term Time Division Multiplexed (TDM) communication pattern.

FIG. 4 illustrates two examples of a long-term TDM communication pattern that include an underlying CSAT timing pattern overlaid with Type I and Type II AOS timing patterns, respectively.

FIG. 5 illustrates a flowchart for selection of an AOS alignment and selection between Type I and Type II AOS timing patterns.

FIG. 6 is a flow diagram illustrating an example method for managing operation of an access point.

FIG. 7 is a block diagram of several sample aspects of components that may be employed in communication nodes and configured to support communication as taught herein.

### DETAILED DESCRIPTION

The present disclosure relates generally to an example long-term Time Division Multiplexed (TDM) communication scheme referred to herein as Carrier Sense Adaptive Transmission (CSAT). Access points implementing CSAT may be configured to synchronize various communication patterns and related measurement periods (e.g., for access terminal measurements, other-RAT scanning, neighbor list scanning, medium utilization scanning, etc.) with timing patterns of the host Radio Access Technology (RAT). In some implementations, synchronization may be achieved based on absolute timing information (e.g., a Coordinated Universal Time, or “UTC”, acquired using a Global Positioning System (GPS) signal). In other implementations, synchronization may be achieved by adopting system timing, such as the Long Term Evolution (LTE) System Frame Number (SFN) numerology (e.g., by performing a Network Listen (NL)). The two synchronization techniques are associated with different timing patterns. Both timing patterns include an Always-On-State (AOS) period, in which an access point can transmit freely, and access terminals from the surrounding wireless environment are given an opportunity to conduct measurements. However, the duration and periodicity of the AOS periods changes based on which synchronization technique is used.

A “Type I” AOS timing pattern is associated with AOS periods having a relatively long duration (the time between the beginning of a given AOS period and the end of the given AOS period) and a relatively long periodicity (the time between the beginning of a given AOS period and the beginning of the subsequent AOS period). A Type I AOS timing pattern must be aligned using absolute timing information. A “Type II” AOS timing pattern, by contrast, is associated with AOS periods having a relatively short duration and a relatively short periodicity, and need not be aligned using absolute timing information. In certain scenarios, an access point may prefer to implement a Type I AOS timing pattern, but may be prevented from doing so because it lacks absolute timing information. In accordance with the present disclosure, the access point may attempt to directly acquire absolute timing information. If these attempts fail, the access point may attempt to indirectly obtain absolute timing information by listening to the network. If absolute timing information cannot be obtained using either technique, then the access point may adopt a Type II AOS timing pattern while continuing to seek out absolute timing information.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

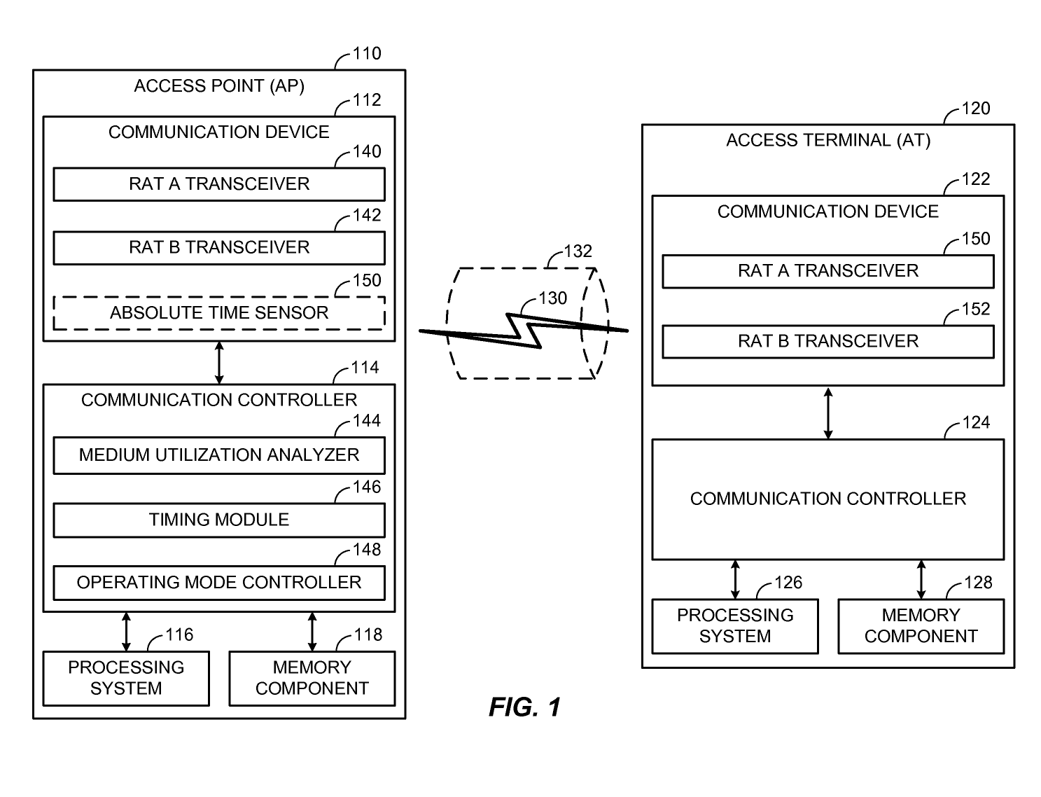

FIG. 1 illustrates an example wireless communication system including an Access Point (AP) in communication with an Access Terminal (AT). Unless otherwise noted, the terms “access terminal” and “access point” are not intended to be specific or limited to any particular Radio Access Technology (RAT). In general, access terminals may be any wireless communication device allowing a user to communicate over a communications network (e.g., a mobile phone, router, personal computer, server, entertainment device, Internet of Things (IOT)/Internet of Everything (IOE) capable device, in-vehicle communication device, etc.), and may be alternatively referred to in different RAT environments as a User Device (UD), a Mobile Station (MS), a Subscriber Station (STA), a User Equipment (UE), etc. Similarly, an access point may operate according to one or several RATs in communicating with access terminals depending on the network in which the access point is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, WiFi APs, other small coverage area APs, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 1, the access point 110 and the access terminal 120 each generally include a wireless communication device (represented by the communication devices 112 and 122) for communicating with other network nodes via at least one designated RAT. The communication devices 112 and 122 may be variously configured for transmitting and encoding signals (e.g., messages, indications, information, and so on), and, conversely, for receiving and decoding signals (e.g., messages, indications, information, pilots, and so on) in accordance with the designated RAT. The access point 110 and the access terminal 120 may also each generally include a communication controller (represented by the communication controllers 114 and 124) for controlling operation of their respective communication devices 112 and 122 (e.g., directing, modifying, enabling, disabling, etc.). The communication controllers 114 and 124 may operate at the direction of or otherwise in conjunction with respective host system functionality (illustrated as the processing systems 116 and 126 and the memory components 118 and 128). In some designs, the communication controllers 114 and 124 may be partly or wholly subsumed by the respective host system functionality.

Turning to the illustrated communication in more detail, the access terminal 120 may transmit and receive messages via a wireless link 130 with the access point 110, the message including information related to various types of communication (e.g., voice, data, multimedia services, associated control signaling, etc.). The wireless link 130 may operate over a communication medium of interest, shown by way of example in FIG. 1 as the medium 132, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the access point 110 and the access terminal 120 for the medium 132.

As a particular example, the medium 132 may correspond to at least a portion of an unlicensed frequency band shared with other RATs. In general, the access point 110 and the access terminal 120 may operate via the wireless link 130 according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by Wireless Local Area Network (WLAN) technologies, most notably IEEE 802.11x WLAN technologies generally referred to as “WiFi.”

In the example of FIG. 1, the communication device 112 of the access point 110 includes two co-located transceivers operating according to respective RATs, including a “RAT A” transceiver 140 and a “RAT B” transceiver 142. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a WiFi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The RAT A transceiver 140 and the RAT B transceiver 142 may provide different functionalities and may be used for different purposes. As an example, the RAT A transceiver 140 may operate in accordance with Long Term Evolution (LTE) technology to provide communication with the access terminal 120 on the wireless link 130, while the RAT B transceiver 142 may operate in accordance with WiFi technology to monitor WiFi signaling on the medium 132 that may interfere with or be interfered with by the LTE communications. The communication device 122 of the access terminal 120 may, in some designs, include similar RAT A transceiver and/or RAT B transceiver functionality, as desired. The communication device 112 optionally includes an absolute time sensor 150.

As will be discussed in more detail below, the communication controller 114 of the access point 110 may include a medium utilization analyzer 144, a timing module 146, and an operating mode controller 148, which may operate in conjunction with the RAT A transceiver 140 and/or the RAT B transceiver 142 to manage operation on the medium 132.

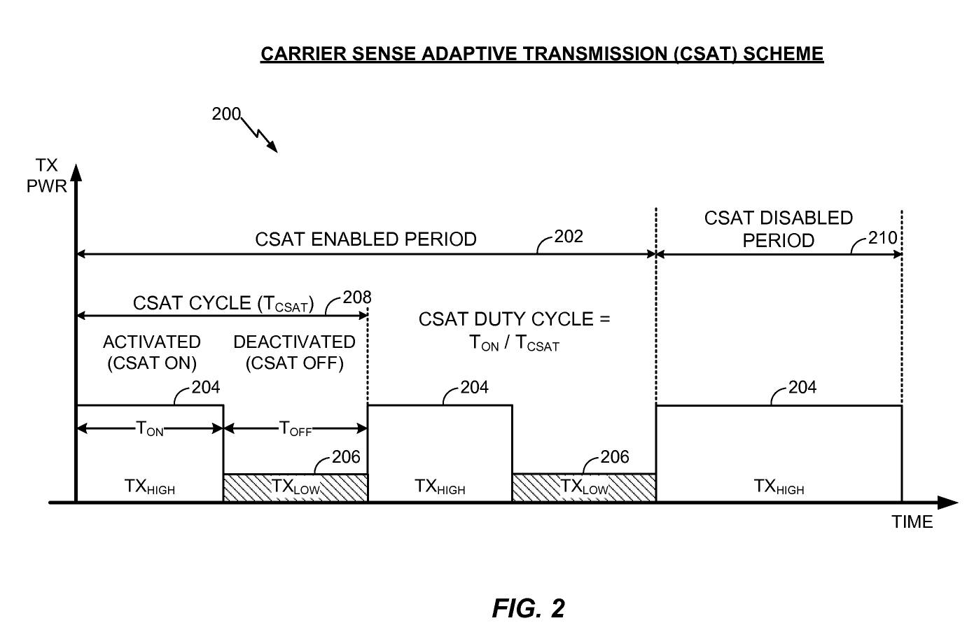

FIG. 2 illustrates certain aspects of an example long-term TDM communication scheme referred to herein as Carrier Sense Adaptive Transmission (CSAT) that may be implemented on the medium 132. A CSAT communication scheme may be used to foster co-existence between RAT A communications between the access point 110 and access terminal 120 and other-RAT communications between neighboring devices operating according to RAT B, for example, by cycling operation of RAT A over the medium 132 in accordance with a CSAT communication pattern. A CSAT communication scheme as provided herein may offer several advantages for mixed-RAT co-existence environments.

As shown, a TDM communication pattern 200 may comprise a CSAT enabled period 202 and a CSAT disabled period 210. During a CSAT enabled period 202, operation of RAT A may be cycled over time between activated periods 204 (CSAT ON) and deactivated periods 206 (CSAT OFF). A given activated period 204/deactivated period 206 pair may constitute a CSAT cycle 208 (having a period T_{CSAT}). During a period of time T_{ON} associated with each activated period 204, RAT A transmission on the medium 132 may proceed at a normal, relatively high transmission power. During a period of time T_{OFF} associated with each deactivated period 206, however, RAT A transmission on the medium 132 is reduced or even fully disabled to yield the medium 132 to neighboring devices operating according to RAT B. By contrast, during a CSAT disabled period 210, the cycling may be disabled.

Each of the associated CSAT parameters, including, for example, CSAT cycle boundary, CSAT cycle periodicity, duty cycle (i.e., T_{ON}/T_{CSAT}) and transmission power, may be adapted based on the current signaling conditions on the medium 132 to dynamically optimize the CSAT communication scheme. For example, the RAT B transceiver 142 configured to operate in accordance with RAT B (e.g., WiFi) may be further configured to monitor the medium 132 for RAT B signaling (transmitted by, for example, neighboring nodes), which may interfere with or be interfered with by RAT A communications over the medium 132. The medium utilization analyzer 144 may be configured to determine a utilization metric associated with utilization of the medium 132 by the RAT B signaling. Based on the utilization metric, one or more CSAT parameters may be set by the operating mode controller 148 and the RAT A transceiver 140 may be further configured to cycle between activated periods 204 and deactivated periods 206. As an example, if the utilization metric is high (e.g., above a utilization threshold), one or more of the parameters may be adjusted such that usage of the medium 132 by the RAT A transceiver 140 is reduced (e.g., via a decrease in the duty cycle or transmission power). Conversely, if the utilization metric is low (e.g., below a utilization threshold), one or more of the parameters may be adjusted such that usage of the medium 132 by the RAT A transceiver 140 is increased (e.g., via an increase in the duty cycle or transmission power).

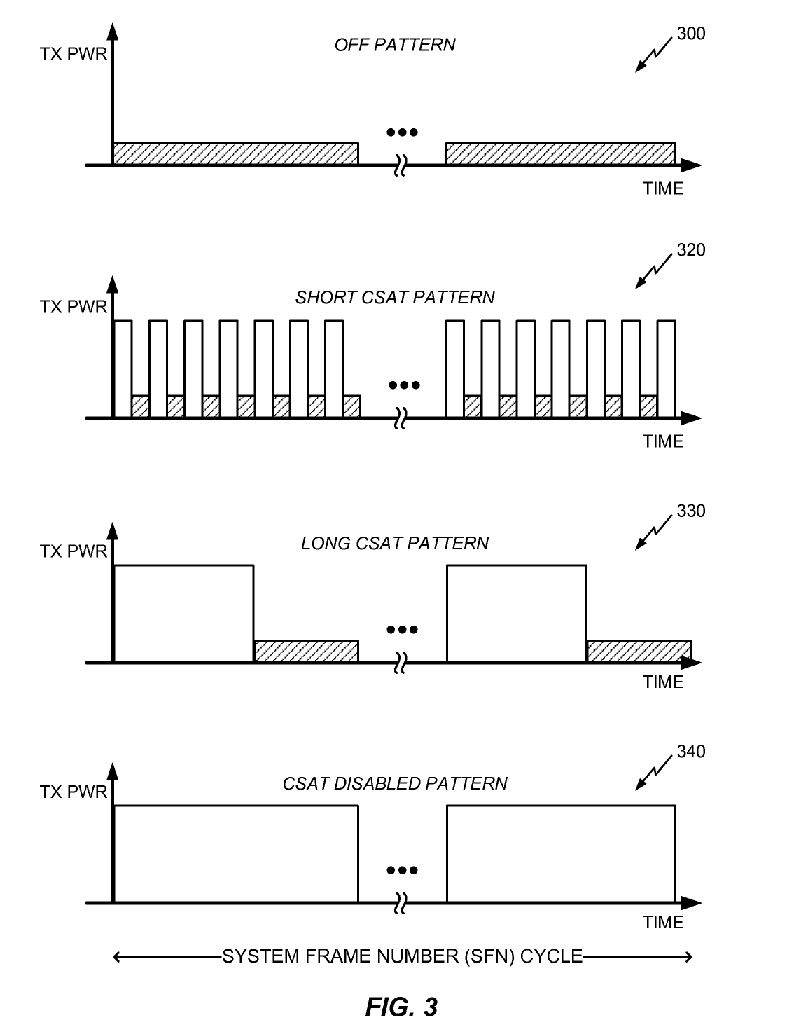

FIG. 3 illustrates four examples of RAT A operations in accordance with a CSAT communication scheme. The off pattern 300 may be selected by the operating mode controller 148 when, for example, the medium utilization analyzer 144 determines that present traffic needs are being met and that RAT A operations are not necessary.

The short CSAT pattern 320 has a short CSAT cycle with compact but more frequent deactivated periods. The short CSAT pattern 320 may have, for example, a period T_{CSAT} of 80 milliseconds and a duty cycle of 0.5 (in which T_{ON}=T_{OFF}=40 milliseconds). The long CSAT pattern 330 has a long CSAT cycle (relative to the CSAT cycle of short CSAT pattern 320) with extended but less frequent deactivated periods. The long CSAT pattern 330 may have, for example, a period T_{CSAT} of 640 milliseconds and a duty cycle of 0.5 (in which T_{ON}=T_{OFF}=320 milliseconds). In general, the long CSAT pattern 330 may be better suited to accommodate neighboring impacted nodes such as nearby Wi-Fi APs. Conversely, the short CSAT pattern 320 may be better suited to accommodate hidden impacted nodes such as hidden Wi-Fi STAs. The CSAT disabled pattern 340 is devoid of deactivated periods and is best suited for RAT A operations on clean channels. Because the CSAT disabled pattern 340 is devoid of deactivated periods, it has a duty cycle of 1.

Although FIG. 3 shows different CSAT patterns having different CSAT cycles and/or duty cycles, it will be understood that the operating mode controller 148 can set other parameters as well. For example, the operating mode controller 148 may adjust transmission power of the CSAT pattern during activated periods. Moreover, the period of the CSAT cycles T_{CSAT} set by the operating mode controller 148 is not restricted to 80 milliseconds or 640 milliseconds, but may in fact be any suitable value. Finally, the duty cycles of the CSAT patterns are not restricted to 0, 0.5, and 1, but may in fact be set to any duty cycle value between 0 and 1 (inclusive).

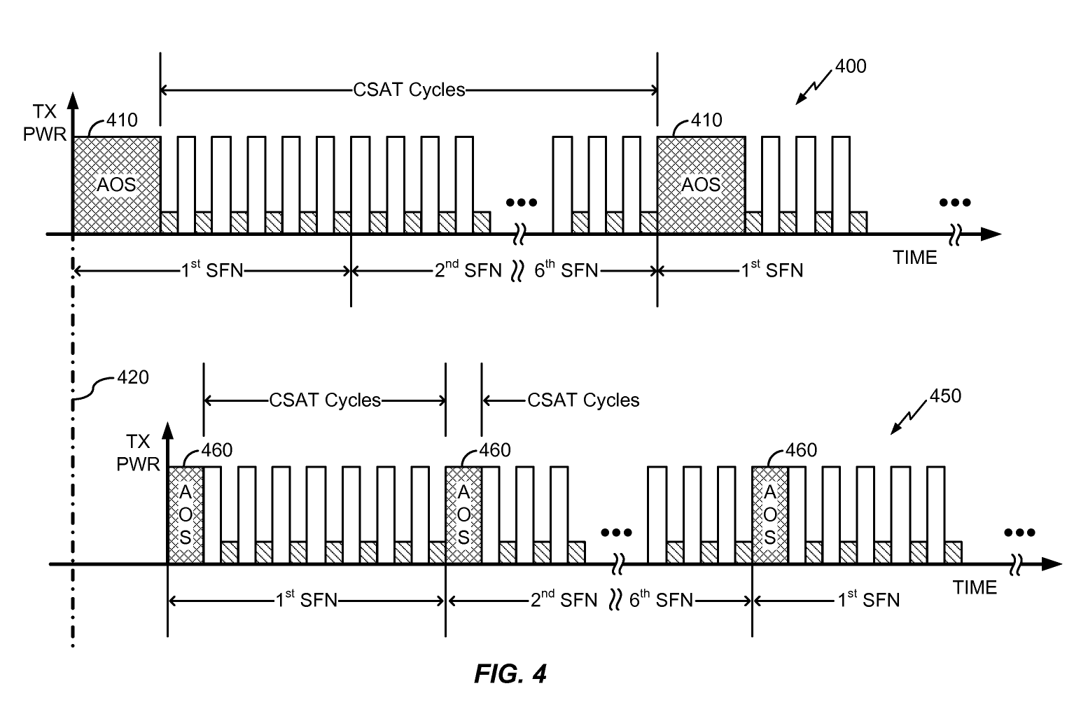

FIG. 4 illustrates two examples of RAT A operations in accordance with an AOS-modified CSAT communication scheme. The AOS-modified CSAT communication scheme includes an underlying CSAT communication pattern (the parameters of which may be set, for example, in accordance with the description of FIGS. 2-3). The underlying CSAT communication pattern is “overlaid” with AOS periods to form the AOS-modified CSAT communication scheme. AOS periods provide, among other potential benefits, measurement opportunities for access terminal Radio Resource Management (RRM) measurements (e.g., Reference Signal Received Power (RSRP) or Reference Signal Received Quality (RSRQ) measurements), which may be used for CHS operations in addition to conventional access terminal functionality.

During the AOS periods, the access point can freely operate on RAT A. These operations are similar to the access point operations on RAT A during, for example, the activated periods 204 of FIG. 2.

Returning to FIG. 4, both of the example AOS-modified CSAT communication patterns 400, 450 have the same underlying CSAT communication pattern. The underlying CSAT communication depicted in FIG. 4 is selected arbitrarily for the purpose of illustrating overlay of AOS periods.

Each of the example AOS-modified CSAT communication patterns 400, 450 is associated with a series of SFN cycles (labeled in FIG. 4 as “1^{st} SFN”, “2^{nd} SFN”, etc.), and each SFN cycle is divided into multiple CSAT cycles. Although FIG. 4 depicts eight underlying CSAT cycles per SFN cycle, it will be understood that FIG. 4 is not drawn to scale, and that the number of CSAT cycles per SFN cycle is selected arbitrarily.

Once an underlying CSAT pattern is adopted, it may be overlaid with, for example, either what is referred to herein as a “Type I” AOS timing pattern or a “Type II” AOS timing pattern. In a Type I AOS timing pattern, the AOS periods 410 have a relatively long duration and a relatively long periodicity. In a Type II AOS timing pattern, by contrast, the AOS periods 460 have a relatively short duration and a relatively short periodicity. According to one particular implementation, an AOS period is a long-duration AOS period if its duration exceeds a duration threshold, and the AOS period is a short-duration AOS period if its duration does not exceed that duration threshold. Similarly, in one particular implementation, an AOS timing pattern is a Type I AOS timing pattern if the periodicity of its AOS periods exceeds a periodicity threshold, and the AOS timing pattern is a Type II AOS timing pattern if the periodicity of its AOS periods does not exceed a periodicity threshold.

In FIG. 4, the first AOS-modified CSAT communication pattern 400 includes the underlying CSAT pattern overlaid with a Type I AOS timing pattern (having relatively long and infrequent AOS periods 410). The second AOS-modified CSAT communication pattern 450 depicted in FIG. 4 includes the same underlying CSAT pattern, but is overlaid with a Type II AOS timing pattern (having relatively short and frequent AOS periods 460).

In one particular implementation, the first AOS-modified CSAT communication pattern 400 includes long-duration AOS periods 410, each of which is 1.28 seconds long (not drawn to scale). Moreover, the long-duration AOS periods 410 are repeated at the beginning of every sixth SFN cycle. In other words, the first AOS-modified CSAT communication pattern 400 is repeated every six SFN cycles. The first SFN cycle begins with a long-duration AOS period 410 (in which the access point operates freely on RAT A) and is followed by the underlying CSAT pattern (in which the access point operates on RAT A in accordance with the relevant CSAT parameters, for example, duty cycle, etc.). The underlying CSAT pattern continues throughout the remainder of the first SFN cycle and throughout the entireties of the second, third, fourth, fifth, and sixth SFN cycles. Upon completing the sixth SFN cycle, the first AOS-modified CSAT communication pattern 400 repeats, beginning with a long-duration AOS period 410 (as noted above). In implementations where a single SFN cycle has a period of 10.24 seconds, the first AOS-modified CSAT communication pattern 400 repeats every 64 seconds (approximately).

Importantly, the parameters of the first AOS-modified CSAT communication pattern 400 are set so that the first long-duration AOS period 410 (or a future long-duration AOS period 410) begins at the same time as a Coordinated Universal Time (UTC) hour 420. In order to ensure that the timing of the first AOS-modified CSAT communication pattern 400 aligns with the beginning of a UTC hour 420, the access point must obtain absolute timing information. The absolute timing information may be obtained by, for example, the timing module 146 illustrated in FIG. 1. In some implementations, the timing module 146 may obtain the absolute timing information by operating in tandem with the optional absolute time sensor 150.

In one particular implementation, the second AOS-modified CSAT communication pattern 450 includes intermittent short-duration AOS periods 460, each of which is 320 milliseconds long (not drawn to scale). Moreover, the short-duration AOS period 460 is repeated at the beginning of every SFN cycle. In implementations where a single SFN cycle has a period of 10.24 seconds, a new short-duration AOS period 460 will begin every 10.24 seconds. In contrast to the first AOS-modified CSAT communication pattern 400, the second AOS-modified CSAT communication pattern 450 is not deliberately aligned with the UTC hour 420. Accordingly, the access point can operate in accordance with the second AOS-modified CSAT communication pattern 450 without obtaining absolute timing information. Instead, the access point performs network listening in order to ascertain the SFN cycles being observed in the surrounding wireless environment. The beginning of each short-duration AOS period 460 aligns with the beginning of an SFN cycle. The SFN cycles may be ascertained by, for example, the timing module 146 illustrated in FIG. 1. In some implementations, the timing module 146 may ascertain the SFN cycles by operating in tandem with the RAT A transceiver 140 and/or the RAT B transceiver 142.

In both the first AOS-modified CSAT communication pattern 400 and the second AOS-modified CSAT communication pattern 450 illustrated in FIG. 4, the access point operates in accordance with the underlying CSAT communication pattern between the end of the previous AOS period and the beginning of the next AOS period. The CSAT pattern set by the operating mode controller 148 may be similar to any of the TDM communication patterns 200, 320, 330, or 340 illustrated in FIGS. 2-3. The period of the CSAT cycle T_{CSAT} and/or the CSAT duty cycle may be held constant during the period between AOS periods. Alternatively, the underlying CSAT pattern may shift among any of the TDM communication patterns 200, 320, 330, 340. In yet another alternative, the parameters that define the underlying CSAT pattern may be continuously variable. In some implementations, the operating mode controller 148 continuously or intermittently adjusts one or more parameters of the CSAT pattern based on the utilization metrics determined by the medium utilization analyzer 144.

The operating mode controller 148 may also determine whether the Type I AOS timing pattern (having long-duration AOS periods 410) or the Type II AOS timing pattern (having short-duration AOS periods 460) will overlay the underlying CSAT communication pattern. The resulting TDM communication pattern is then used by the RAT A transceiver 140 to determine when it may freely operate (e.g., during activated periods such as activated period 204, long-duration AOS period 410, and short-duration AOS period 460) and when it may not (e.g., during deactivated periods such as deactivated period 206).

A consistent cycle-to-cycle timing for the AOS period is beneficial because it enables coordination of access terminal measurement opportunities across multiple access points in a given wireless environment. Generally, an access point that can directly obtain absolute timing information (using, e.g., the optional absolute time sensor 150) will adopt a system-independent Type I AOS timing pattern. Every access point in the wireless environment that can obtain absolute timing information will naturally adopt the same Type I AOS timing pattern and as a result, these access points will be mutually synchronized. An access point that cannot obtain absolute timing information will rely on network listening to discern the SFN cycle being used by a neighboring node. If the neighboring node is using a system-specific Type II AOS timing pattern, the access point will recognize and adopt the timing of the neighboring node's SFN cycles.

However, under some circumstances, the short-duration AOS period 460 of the Type II AOS timing pattern is not sufficient to, for example, complete performance of inter-frequency measurements by access terminals in the wireless environment. As a result, the access terminals must rely on best-effort attempts. In some implementations, the inter-frequency measurements must be rescheduled for the next short-duration AOS period 460, resulting in additional radio resource control (RRC) overhead. A long-duration AOS period 410, by contrast, may permit completion of inter-frequency measurements. Accordingly, the access point may prefer to overlay a Type I AOS timing pattern having long-duration AOS periods 410.

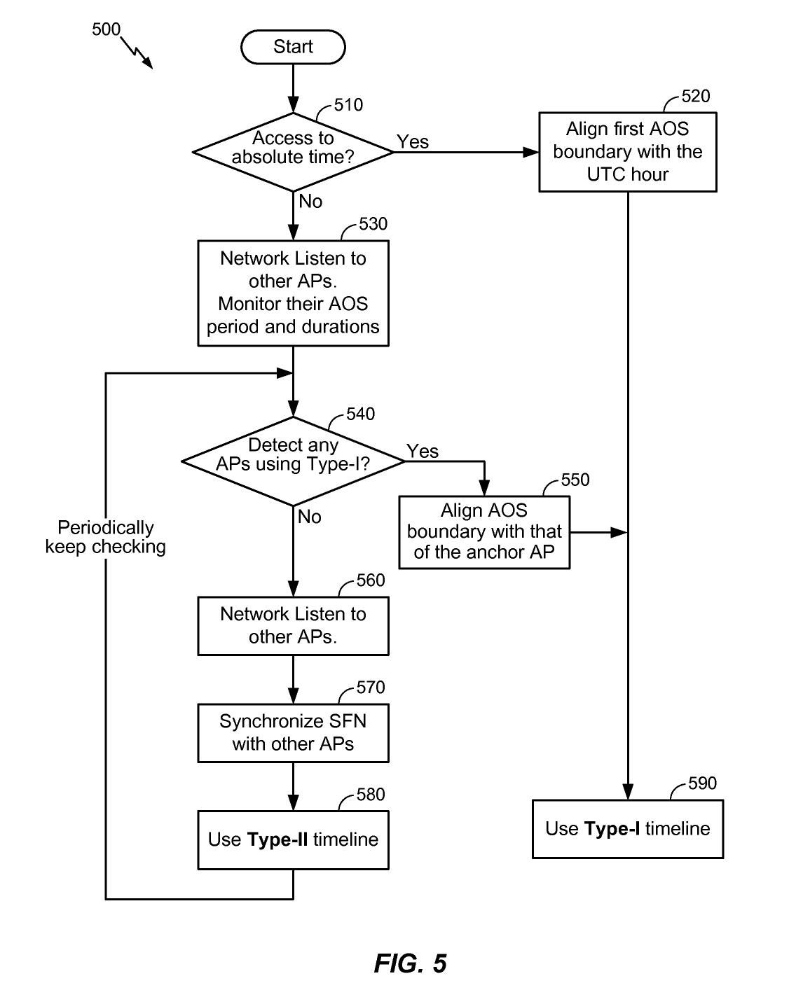

FIG. 5 illustrates a flow diagram for managing RAT A operations over a communication medium shared with RAT B. In particular, FIG. 5 illustrates a process 500 for preferentially utilizing a Type I AOS timing pattern, and obtaining the absolute timing information necessary to implement the Type I AOS timing pattern. The process may be performed by an access point, for example, the access point 110 of FIG. 1.

First, the access point 110 determines whether absolute timing information is available (block 510). For example, the timing module 146 may determine whether the access point 110 is equipped with an absolute time sensor 150 and whether the absolute time sensor 150 is able to receive absolute timing information. In one particular implementation, the absolute time sensor 150 is a GPS sensor that receives an indication of the timing of a UTC hour. If the absolute time sensor 150 is able to receive the absolute timing information, then the timing module 146 may use the absolute timing information to determine when the next UTC hour will begin.

If the access point has direct access to absolute timing information (‘yes’ at block 510), then the access point 110 will align the beginning (or “boundary”) of a long-duration AOS period 410 with the indicated UTC hour (block 520). After alignment is complete, the process 500 will adopt a Type I AOS timing pattern that includes the aligned long-duration AOS period 410 (block 590). The alignment of the long-duration AOS period 410 (block 520) and the adoption of the Type I AOS timing pattern may be performed by, for example, the operating mode controller 148. The operating mode controller 148 may also select an underlying CSAT pattern (such as, for example, TDM communication pattern 200, 320, 330, or 340) in accordance with any technique set forth in the present disclosure and align the selected CSAT pattern in the same manner as the Type I AOS timing pattern.

If the access point 110 does not have direct access to absolute timing information (‘no’ at block 510), then the access point 110 will perform a network listen (block 530). In some implementations, the access point 110 can determine (at block 510) that absolute timing information is not available by determining that the access point 110 is not equipped with an absolute time sensor 150. In other implementation, the access point 110 may in fact be equipped with an absolute time sensor 150, but may determine (at block 510) that valid absolute timing information cannot be obtained from the absolute time sensor 150 (e.g., because the absolute time sensor 150 is malfunctioning, an absolute time signal received by the absolute time sensor 150 is lost, etc.).

During the network listen, the access point 110 may monitor the RAT A communications of neighboring nodes to discern the communication patterns of the neighboring nodes. The network listening may be performed by, for example, the RAT A transceiver 140 and/or the RAT B transceiver 142. If a neighboring node is utilizing a Type I AOS timing pattern, the access point 110 will detect communications from the neighboring node that are consistent with a Type I AOS timing pattern (block 540). For example, the access point 110 may recognize a Type I AOS timing pattern based on a duration of a detected AOS period, a length of time between detected AOS periods, or both.

The detection (at block 540) may be performed by, for example, the timing module 146, in tandem with the RAT A transceiver 140 and/or the RAT B transceiver 142. According to one particular implementation, the timing module 146 attempts to distinguish a Type I AOS timing pattern (having long-duration AOS periods 410 with a duration of 1.24 seconds) from a Type II AOS timing pattern (having short-duration AOS periods 460 with a duration of 320 milliseconds). It will be understood that the timing module 146 may be able to recognize a long-duration AOS period 410 by comparing the duration of the detected AOS period to a duration threshold. For example, the duration threshold may be equal to 320 milliseconds (which is the maximum duration of the short-duration AOS period 460), 1.24 seconds (which is the minimum duration of the long-duration AOS period 410), or some value in between (for example, the halfway point of 780 milliseconds). It will be further understood that the timing module 146 may (additionally or alternatively) be able to recognize a Type I AOS timing pattern by comparing the periodicity of the detected AOS periods to a periodicity threshold. For example, the periodicity threshold may be equal to 10.24 seconds (which is the maximum periodicity of the Type II AOS timing pattern), 64 seconds (which is the minimum periodicity of the Type I AOS timing pattern), or some value in between (for example, the halfway point of approximately 37 seconds).

If the access point 110 determines that a neighboring node is using a Type I AOS timing pattern (‘yes’ at block 540), then the access point 110 will identify that neighboring node as an anchor node. As used herein, an anchor node refers to a node that serves as a reference for other nodes with respect to AOS period timing. The access point 110 will then align the beginning of a long-duration AOS period 410 with the detected beginning of the anchor node's Type I AOS timing pattern (block 550). It will be understood that the detected beginning of the anchor node's AOS timing pattern is presumably based on absolute timing information, and that the access point 110 can indirectly obtain the absolute timing information simply by detecting the beginning of the anchor node's Type I AOS timing pattern. After alignment is complete (at block 550), the access point 110 will adopt a Type I AOS timing pattern that includes the beginning boundary of the aligned long-duration AOS period 410 as a starting point (block 590). The alignment of the long-duration AOS period 410 (block 550) and the adoption of the Type I AOS timing pattern may be performed by, for example, the operating mode controller 148. The operating mode controller 148 may also select an underlying CSAT pattern (such as, for example, TDM communication pattern 200, 320, 330, or 340) in accordance with any technique set forth in the present disclosure and align the selected CSAT pattern in the same manner as the Type I AOS timing pattern.

If the access point 110 determines that there are no neighboring nodes using a Type I AOS timing pattern (‘no’ at block 540), then the access point 110 will perform a network listen (block 560). The network listening may be performed by, for example, the RAT A transceiver 140. If a neighboring node is using a Type II AOS timing pattern, then the access point 110 will identify the beginning of the neighboring node's SFN cycles. The access point 110 will then align the beginning of a short-duration AOS period 460 with the detected beginning of the neighboring node's SFN cycle (block 570). It will be understood that the detected beginning of the neighboring node's SFN cycle coincides with the beginning of the neighboring node's Type II AOS timing pattern. After alignment is complete, the access point 110 will adopt a Type II AOS timing pattern that includes the aligned short-duration AOS period 460 (block 580).

It will be understood from FIG. 5 that after adopting a Type II AOS timing pattern (at block 580), the access point 110 may still prefer to adopt a Type I AOS timing pattern. Accordingly, the process 500 may continue to perform network listening (e.g., intermittently) and loop back to reassess whether there are any neighboring nodes using a Type I AOS timing pattern (as in block 540). By doing so, the access point 110 can then shift to a Type I AOS timing pattern (as in blocks 550 and 590) at the earliest opportunity (should such an opportunity arise). Alternatively, the process 500 may loop back to reassess whether the access point 110 has direct access to absolute timing information (as in block 510).

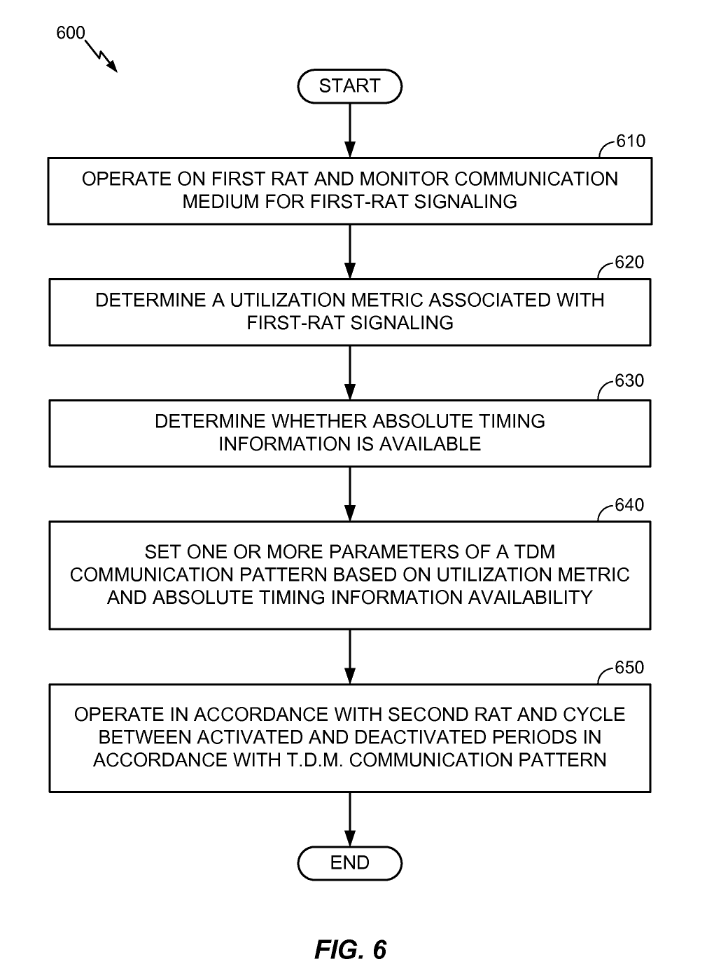

FIG. 6 is a flow diagram illustrates an example method for managing operation of a first RAT over a communication medium shared with a second RAT in accordance with the techniques described above. The method 600 may be performed, for example, by an access point (e.g., the access point 110 illustrated in FIG. 1).

As shown, the access point 110 may operate in accordance with a first RAT and monitor the medium for first RAT signaling (block 610). The operating and monitoring may be performed by, for example, the RAT B transceiver 142 or the like. The access point 110 may further determine a utilization metric associated with utilization of the medium by the first RAT signaling (block 620). The determining may be performed by for example, the medium utilization analyzer 144 or the like. The access point 110 may further determine whether absolute timing information is available (block 630). The determining may be performed by for example, the timing module 146 or the like. The access point 110 may further set one or more parameters of a Time Division Multiplexing (TDM) communication pattern (400, 450) based on the utilization metric and the availability of the absolute timing information (block 640). The setting may be performed by for example, the operating mode controller 148 or the like. The access point 110 may further operate in accordance with a second RAT and cycle between activated periods and deactivated periods of communication over the medium in accordance with the TDM communication pattern (block 650). The operating and cycling may be performed by for example, the RAT A transceiver 140 or the like.

For convenience, the access point 110 and the access terminal 120 are shown in FIG. 1 as including various components that may be configured according to the various examples described herein. It will be appreciated, however, that the illustrated blocks may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality.

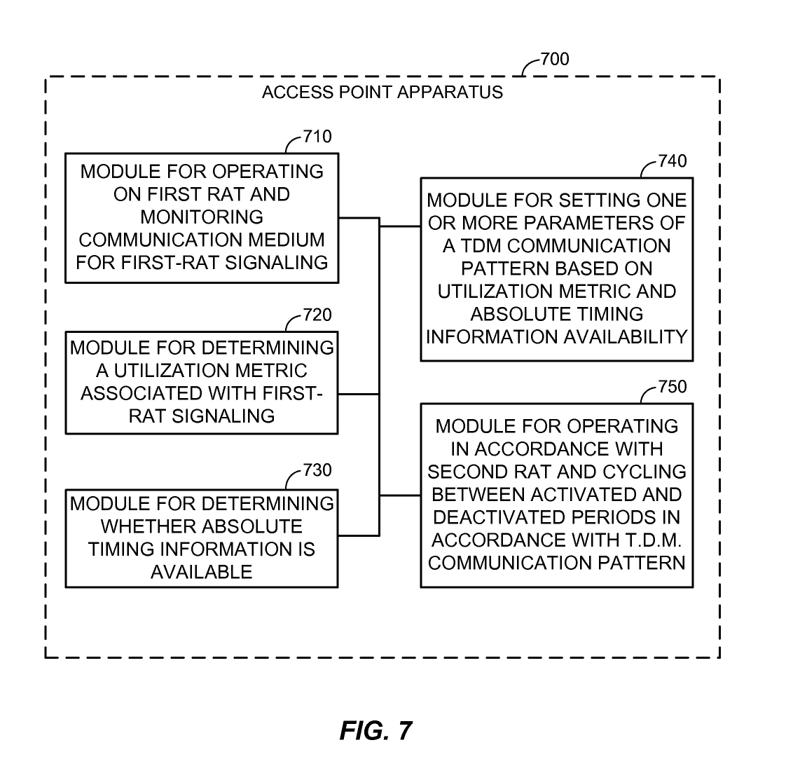

FIG. 7 provides an alternative illustration of an apparatus for implementing the access point 110 represented as a series of interrelated functional modules. In particular, FIG. 7 illustrates an example access point apparatus 700 represented as a series of interrelated functional modules. A module for operating in accordance with a first RAT and monitoring the medium for first RAT signaling 710 may correspond at least in some aspects to, for example, a communication device or a component thereof as discussed herein (e.g., the communication device 112 or the like). A module for determining a utilization metric associated with utilization of the medium by the first RAT signaling 720 may correspond at least in some aspects to, for example, a communication controller or a component thereof as discussed herein (e.g., the communication controller 114 or the like). A module for determining whether absolute timing information is available 730 may correspond at least in some aspects to, for example, a communication controller or a component thereof as discussed herein (e.g., the communication controller 114 or the like). A module for setting one or more parameters of a time division multiplexing communication pattern based on the utilization metric and the availability of the absolute timing information 740 may correspond at least in some aspects to, for example, a communication controller or a component thereof as discussed herein (e.g., the communication controller 114 or the like). A module for operating in accordance with a second RAT and cycling between activated periods and deactivated periods of communication over the medium in accordance with the time division multiplexing communication pattern 750 may correspond at least in some aspects to, for example, a communication device or a component thereof as discussed herein (e.g., the communication device 112 or the like).

The functionality of the modules of FIG. 7 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein. For example, the components described above in conjunction with the “module for” components of FIG. 7 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for communication management between RATs sharing operating spectrum in an unlicensed band of radio frequencies. As an example, such a computer-readable medium may include code for operating in accordance with a first RAT and monitoring the medium for first RAT signaling, code for determining a utilization metric associated with utilization of the medium by the first RAT signaling, code for determining whether absolute timing information is available, code for setting one or more parameters of a Time Division Multiplexing (TDM) communication pattern based on the utilization metric and the availability of the absolute timing information, and code for operating in accordance with a second RAT and cycling between activated periods and deactivated periods of communication over the medium in accordance with the TDM communication pattern.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. An apparatus for managing operation of a first Radio Access Technology (RAT) over a communication medium shared with a second RAT, comprising:
a first transceiver configured to operate in accordance with a first RAT and to monitor the medium for first RAT signaling;
a medium utilization analyzer configured to determine a utilization metric associated with utilization of the medium by the first RAT signaling;
a timing module configured to determine whether absolute timing information is available;
an operating mode controller configured to set one or more parameters of a Time Division Multiplexing (TDM) communication pattern based on the utilization metric and the availability of the absolute timing information; and
a second transceiver configured to operate in accordance with a second RAT and to cycle between activated periods and deactivated periods of communication over the medium in accordance with the TDM communication pattern.

2. The apparatus of claim 1, wherein the timing module is further configured to:
determine whether absolute timing information can be obtained directly; and
discern a communication pattern of an anchor node operating on the communication medium in response to a determination that the absolute timing information cannot be obtained directly.

3. The apparatus of claim 2, wherein:
the second transceiver is configured to perform network listening; and
the timing module is configured to discern the communication pattern of the anchor node based on the network listening performed by the second transceiver.

4. The apparatus of claim 2, wherein the timing module is configured to:
determine whether the communication pattern of the anchor node includes an anchor always on state period (AOS period);
determine whether a duration of the anchor AOS period exceeds a duration threshold or whether a periodicity of the anchor AOS period exceeds a periodicity threshold; and
obtain absolute timing information based on a start time of the anchor AOS period in response to a determination that the duration or periodicity of the anchor AOS period exceeds the duration threshold or periodicity threshold.

5. The apparatus of claim 4, wherein the operating mode controller is configured to set a start time of the TDM communication pattern in accordance with the absolute timing information obtained by the timing module.

6. The apparatus of claim 5, wherein the operating mode controller is configured to set the TDM communication pattern such that it begins with a long-duration AOS period having a long duration that exceeds a duration threshold.

7. The apparatus of claim 1, wherein the timing module is configured to determine that absolute timing information can be obtained directly if the apparatus comprises an absolute time sensor and the absolute time sensor has received valid absolute timing information.

8. The apparatus of claim 7, wherein the operating mode controller is configured to:
set a start time of the TDM communication pattern in accordance with the absolute timing information obtained by the timing module; and
set the TDM communication pattern such that it begins with a long-duration AOS period having a long duration that exceeds a duration threshold and a long period that exceeds a periodicity threshold.

9. The apparatus of claim 1, wherein, in response to a determination that absolute timing information is not available, the operating mode controller is configured to set the TDM communication pattern such that it begins with a short-duration AOS period having a short duration that does not exceed a duration threshold and has a short period that does not exceed a periodicity threshold.

10. The apparatus of claim 9, wherein the timing module iteratively determines whether absolute timing information becomes available, and, in response to a determination that absolute timing information has become available, the operating mode controller is configured to:
set a start time of the TDM communication pattern in accordance with the absolute timing information obtained by the timing module; and
set the TDM communication pattern such that it begins with a long-duration AOS period having a long duration that exceeds a duration threshold and a long period that exceeds a periodicity threshold.

11. A method for managing operation of a first Radio Access Technology (RAT) over a communication medium shared with a second RAT, comprising:
operating in accordance with a first RAT and monitoring the medium for first RAT signaling;
determining a utilization metric associated with utilization of the medium by the first RAT signaling;
determining whether absolute timing information is available;
setting one or more parameters of a Time Division Multiplexing (TDM) communication pattern based on the utilization metric and the availability of the absolute timing information; and
operating in accordance with a second RAT and cycling between activated periods and deactivated periods of communication over the medium in accordance with the TDM communication pattern.

12. The method of claim 11, further comprising:
determining whether absolute timing information can be obtained directly; and
discerning a communication pattern of an anchor node operating on the medium in response to a determination that the absolute timing information cannot be obtained directly.

13. The method of claim 12, wherein discerning the communication pattern of the anchor node comprises discerning the communication pattern based on network listening.

14. The method of claim 12, further comprising:
determining whether the communication pattern of the anchor node includes an anchor always on state period (AOS period);
determining whether a duration of the anchor AOS period exceeds a duration threshold or whether a periodicity of the anchor AOS period exceeds a periodicity threshold; and
obtaining absolute timing information based on a start time of the anchor AOS period in response to a determination that the duration or periodicity of the anchor AOS period exceeds the duration threshold or periodicity threshold.

15. The method of claim 14, wherein setting one or more parameters of the TDM communication pattern comprises setting a start time of the TDM communication pattern in accordance with the absolute timing information obtained by the timing module.

16. The method of claim 15, wherein setting one or more parameters of the TDM communication pattern comprises setting the TDM communication pattern such that it begins with a long-duration AOS period having a long duration that exceeds a duration threshold.

17. The method of claim 11, wherein determining whether absolute timing information can be obtained directly comprises determining whether valid absolute timing information has been received.

18. The method of claim 17, wherein setting one or more parameters of the TDM communication pattern comprises:
setting a start time of the TDM communication pattern in accordance with the absolute timing information obtained by the timing module; and
setting the TDM communication pattern such that it begins with a long-duration AOS period having a long duration that exceeds a duration threshold.

19. The method of claim 11, wherein setting one or more parameters of the TDM communication pattern comprises, in response to a determination that absolute timing information is not available, setting the TDM communication pattern such that it begins with a short-duration AOS period having a short duration that does not exceed a duration threshold and has a short period that does not exceed a periodicity threshold.

20. The method of claim 19, further comprising iteratively determining whether absolute timing information becomes available, and, in response to a determination that absolute timing information has become available:
setting a start time of the TDM communication pattern in accordance with the absolute timing information obtained by the timing module; and
setting the TDM communication pattern such that it begins with a long-duration AOS period having a long duration that exceeds a duration threshold.

21. An apparatus for managing operation of a first Radio Access Technology (RAT) over a communication medium shared with a second RAT, comprising:
means for operating in accordance with a first RAT and monitoring the medium for first RAT signaling;
means for determining a utilization metric associated with utilization of the medium by the first RAT signaling;
means for determining whether absolute timing information is available;
means for setting one or more parameters of a Time Division Multiplexing (TDM) communication pattern based on the utilization metric and the availability of the absolute timing information; and
means for operating in accordance with a second RAT and cycling between activated periods and deactivated periods of communication over the medium in accordance with the TDM communication pattern.

22. The apparatus of claim 21, wherein means for determining whether absolute timing information is available further comprises:
means for determining whether absolute timing information can be obtained directly; and
means for discerning a communication pattern of an anchor node operating on the medium in response to a determination that the absolute timing information cannot be obtained directly.

23. The apparatus of claim 22, wherein means for discerning the communication pattern of the anchor node comprises means for discerning the communication pattern based on network listening.

24. The apparatus of claim 22, wherein means for determining whether absolute timing information is available further comprises:
means for determining whether the communication pattern of the anchor node includes an anchor always on state period (AOS period);
means for determining whether a duration of the anchor AOS period exceeds a duration threshold or whether a periodicity of the anchor AOS period exceeds a periodicity threshold; and
means for obtaining absolute timing information based on a start time of the anchor AOS period in response to a determination that the duration or periodicity of the anchor AOS period exceeds the duration threshold or periodicity threshold.

25. The apparatus of claim 24, wherein means for setting one or more parameters of the TDM communication pattern comprises means for setting a start time of the TDM communication pattern in accordance with the absolute timing information obtained by the timing module.

26. A non-transitory computer-readable medium comprising at least one instruction for causing a processor to perform processes for managing communication in accordance with a second RAT on a channel shared with a first RAT, comprising:
code for operating in accordance with a first RAT and monitoring the medium for first RAT signaling;
code for determining a utilization metric associated with utilization of the medium by the first RAT signaling;
code for determining whether absolute timing information is available;
code for setting one or more parameters of a Time Division Multiplexing (TDM) communication pattern based on the utilization metric and the availability of the absolute timing information; and
code for operating in accordance with a second RAT and cycling between activated periods and deactivated periods of communication over the medium in accordance with the TDM communication pattern.

27. The non-transitory computer-readable medium of claim 26, wherein code for determining whether absolute timing information is available further comprises:
code for determining whether absolute timing information can be obtained directly; and
code for discerning a communication pattern of an anchor node operating on the medium in response to a determination that the absolute timing information cannot be obtained directly.

28. The non-transitory computer-readable medium of claim 27, wherein code for discerning the communication pattern of the anchor node comprises code for discerning the communication pattern based on network listening.

29. The non-transitory computer-readable medium of claim 27, wherein code for determining whether absolute timing information is available further comprises:
code for determining whether the communication pattern of the anchor node includes an anchor always on state period (AOS period);
code for determining whether a duration of the anchor AOS period exceeds a duration threshold or whether a periodicity of the anchor AOS period exceeds a periodicity threshold; and
code for obtaining absolute timing information based on a start time of the anchor AOS period in response to a determination that the duration or periodicity of the anchor AOS period exceeds the duration threshold or periodicity threshold.

30. The non-transitory computer-readable medium of claim 29, wherein code for setting one or more parameters of the TDM communication pattern comprises code for setting a start time of the TDM communication pattern in accordance with the absolute timing information obtained by the timing module.
